(19) United States
(12) Patent Application Publication
(10) Pub. No.: US 2025/0318661 A1
(43) Pub. Date: Oct. 16, 2025

(54) TODDLER TOWER

(71) Applicant: KIDS2, LLC, Atlanta, GA (US)

(72) Inventors: Casey Hopper HARRIS, Brookhaven, GA (US); Cheng-Fang LEE, Atlanta, GA (US); Michael ARMBRUSTER, Clarence Center, NY (US)

(21) Appl. No.: 19/074,829

(22) Filed: Mar. 10, 2025

Related U.S. Application Data
(60) Provisional application No. 63/634,571, filed on Apr. 16, 2024.

(51) Int. Cl. A47D 1/02; A47D 15/00

(52) U.S. Cl. CPC A47D 1/023; A47D 15/006

(57) ABSTRACT

A toddler tower, comprising
a base having a first pair of legs hingeably connected to a second pair of legs,
a child support platform extending between the first and second pairs of legs, and
at least one panel extending between the first and second pairs of legs.

A toddler learning tower for supporting a toddler above a support surface, comprising
a base portion having a first pair of legs connected to a second pair of legs by hinge components, wherein a first leg of the first pair of legs is connected to a first leg of the second pair of legs by a first hinge component and a second leg of the second pair of legs is connected to a second leg of the second pair of legs by a second hinge component;
a child support platform extending between the first and second legs of the first and second pairs of legs at a first elevation above the support surface;
a step platform extending between the first and second legs of at least one of the first or second pairs of legs at a second elevation above the support surface, wherein the second elevation is lower than the first elevation; and
a first soft-goods panel extending between the first legs of the first and second pairs of legs.
a second soft-goods panel extending between the second legs of the first and second pairs of legs.

### CROSS-REFERENCE TO RELATED APPLICATIONS

This application claims the benefit of U.S. Provisional Application No. 63/634,571, filed Apr. 16, 2024, the entire contents of which is hereby incorporated herein by reference.

### TECHNICAL FIELD

The present invention relates generally to the field of children's accessories, and more particularly to a toddler learning tower.

### BACKGROUND

A toddler tower, or also known as a learning tower or kitchen helper tower, is a type of furniture designed to safely elevate young children to a certain height above a ground or support surface, such as for example the height of a kitchen counter. Toddlers towers allow children to explore and engage in hands-on learning experiences alongside adults. For example, a toddler tower may provide an elevated support for a child to participate in kitchen activities, such as cooking or baking, alongside his or her parents without being directly held by the parents. As such, toddler towers can promote independence and confidence in young children by allowing them to participate in everyday activities at the same level as adults. However, there are also safety concerns to consider when using toddler towers. It is to the provision of a toddler tower having new and improved safety features that the present disclosure is primarily directed.

### SUMMARY

In example embodiments, the present invention relates to a toddler learning tower for supporting a child user over a support surface, such as for example the ground or floor of a room. The toddler learning tower comprises a base and a guardrail configured to be secured to the base to provide a safety rail around the child user during use. The base includes a first frame portion or a first pair of legs hingeably connected to a second frame portion or a second pair of legs by a pair of hinge components, and a child support platform extending between the first and second frame portions and configured to support the child user some height above the support surface. For example, the toddler tower can be used as a stool, and the guardrail can provide a safety rail for a child sitting or standing on the support surface.

In some example embodiments, the toddler learning tower further includes one or more panels. The panels may be secured between the first and second pairs of legs. Preferably, the panels are configured to cover or otherwise block openings or gaps defined by the first frame portion, the second frame portion, and the child support platform. In example embodiments, the panels cover the opening or gaps to minimize or eliminate risk of head and neck entrapment in the openings. Preferably, the panels comprise soft-goods material such as for example mesh or fabric liners. In other embodiments, the panels comprise a flexible material such as neoprene or rubber that can be perforated or non-perforated. Additionally, one or more of the panels may comprise one or more integrated pockets for storing other items. Advantageously, the panels can provide for safety or support for a child or carer. Additionally or alternatively, the panels can be decorative, can act as a cover, and/or provide storage. Preferably, the toddler learning tower is reconfigurable between a folded configuration, for example, for storage when not in use, and an open configuration, for example, for use.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a toddler tower according to an example embodiment of the present invention, the toddler tower including side panels on either side thereof.

FIG. 2 is a perspective view of the toddler tower according to another example embodiment of the present invention, the toddler tower including side panels with at least one of the side panels having a pocket for storing other items.

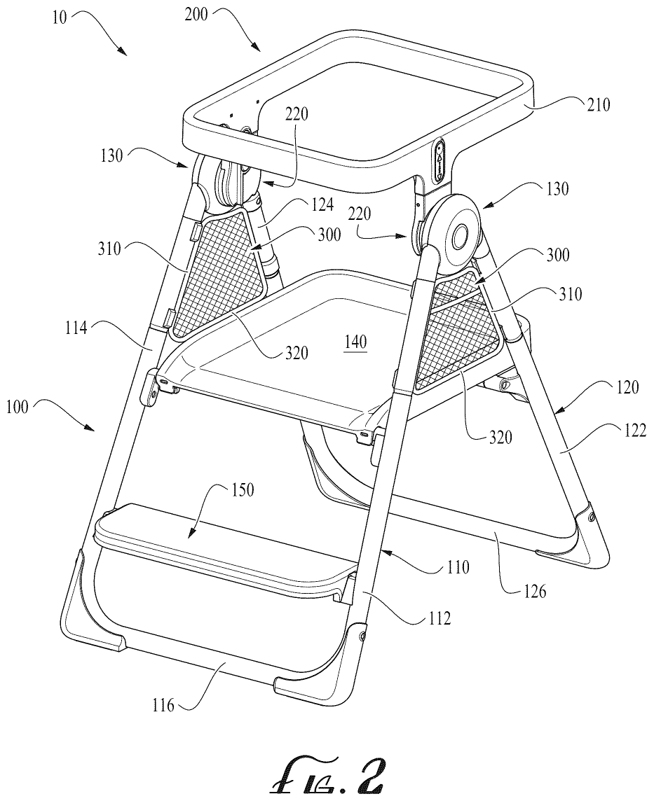

FIGS. 3 and 4 are close-up views of the hinge components and side panels depicted in FIGS. 1 and 2, respectively.

FIG. 5 shows a view of the toddler tower in a folded position with the guardrail attached.

FIG. 6 shows a view of the toddler tower in a folded position with the guardrail detached.

FIG. 7 shows another embodiment of the hinge components of the toddler tower.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

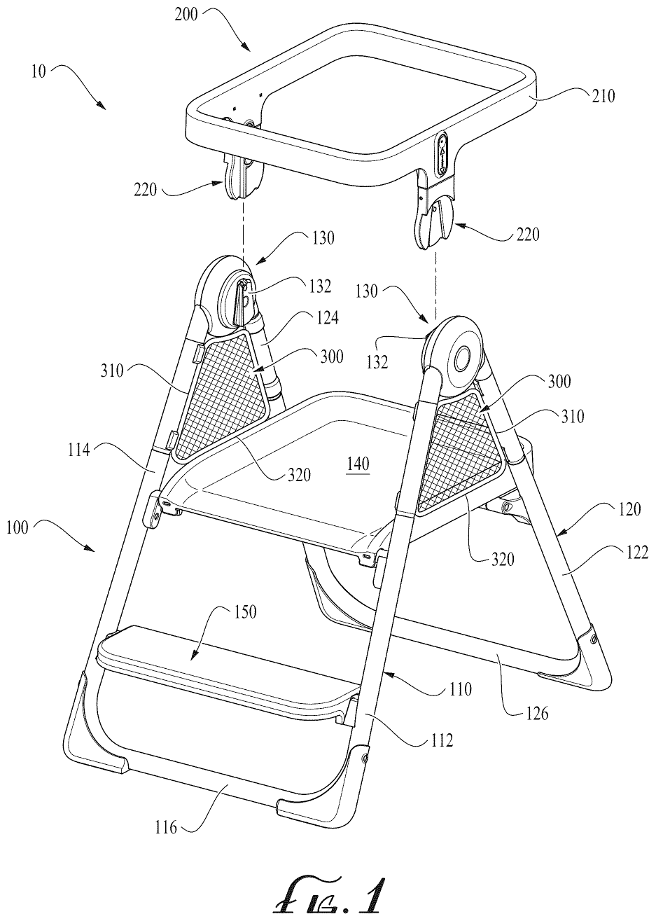

With reference now to the drawing figures, wherein like reference numbers represent corresponding parts throughout the several views, FIG. 1 shows a toddler tower 10 according to an example embodiment of the present invention. Generally, the toddler tower 10 includes a lower frame or base 100 and an upper frame or guardrail 200. The base 100 includes a first, front frame portion 110 or set/pair of legs 110 hingeably connected to a second, rear frame portion or set/pair of legs 120 by a set or pair of hinge components 130. As shown in FIG. 1, the front frame portion 110 includes a first leg 112 and a second leg 114 connected by a front crossbar 116 and the rear frame portion 120 includes a first leg 122 and a second leg 124 connected by rear crossbar 126. Crossbars 116,126 can be at or near the floor level. In the depicted embodiment, the crossbars 116, 126 are integral with legs 112,114 and 122,124, respectively. In other embodiments, the crossbars 116,126 could be non-integrally attached. In yet other embodiments, a crossbar can connect the front legs 112, 144 under the step 150. In some embodiments, gripping elements are coupled to one or both of the legs or crossbars to provide additional stability on hard floors.

A child support platform 140 is provided between the front and rear frame portions 110, 120. The child support platform 140 is configured to support a child user thereon and, thus, parallel to the support surface (i.e., the ground or floor) in use. Preferably, the child support platform 140 is pivotally and/or moveably connected to either the first frame portion 110 or rear frame portion 120 so that the child support platform 140 can be pivoted or moved out of the way to allow the base to be folded to occupy less space when the toddler tower is not in use and/or for storage. The other frame portion—for example, the rear frame portion 120, if the child support platform 140 is pivotally and/or moveably connected to the front frame portion 110, and vice versa—includes a support crossbar or feature to support the free end or portion of the child support platform 140 during use.

The hinge components 130 are generally configured to receive and releasably secure the upper frame or guardrail 200 thereon. In example embodiments, the hinge components 130 include sliding blocks (or protrusions) 132 and the guardrail 200 includes slide rails or guides 220 on opposing sides thereof. In an alternative embodiment (not shown), the hinge components 130 include guides 220 and the guardrail 200 includes mating protrusions 132. In example modes of use, the guardrail 200 is secured to the base 100 by aligning the slide rails 220 of the guardrail 200 to the sliding blocks 132 extending from the hinge components 130 and engaging or otherwise securing the slide rails 220 to the sliding blocks 132. Preferably, the hinge component 130 and/or the guardrail 200 further includes a locking mechanism to selective lock in place the guardrail 200 to the base 100. For example, the locking mechanism may comprise an operable locking pin or actuator to selectively lock or unlock the locking mechanism to secure the guardrail 200 to the base 100 or release the guardrail 200 from the base 100.

The guardrail 200 generally comprises a rail frame 210 configured to encircle or go around the child user in use. In example embodiments, the rail frame 210 comprises a rectangular profile with an opening where the child user stands in during use. However, the rail frame may comprise any other suitable shape or profile, such as for example circular, hexagonal, or semi-circular, as desired or required. In example embodiments, the rail frame 210 includes slide rails or guides 220 on opposing sides or ends thereof. The slide rails 220 generally comprise a groove or channel configured to receive therein the sliding blocks 132 on each hinge component 130. In other example embodiments, the guardrail 200 and base 100 may be configured or comprise other mechanisms or systems for releasably securing the guardrail 200 to the base 100, such as for example latches, clamps, magnets, temporary fasteners, snap-fit connections, and/or any combinations thereof. Advantageously, the guardrail 200 does not need to be removed when the toddler tower 10 is in a folded position.

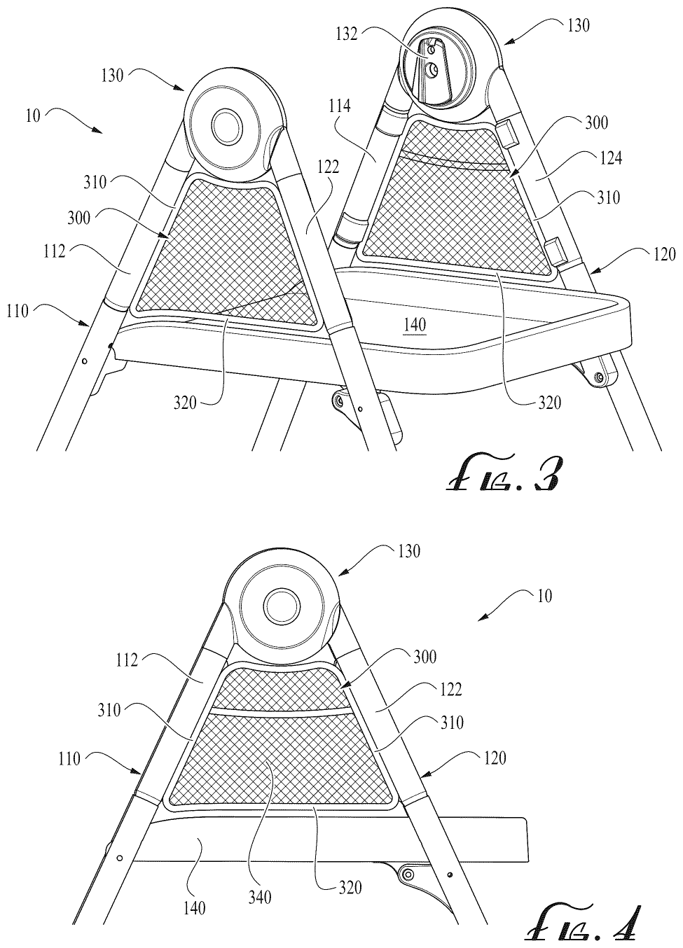

The base 100 generally includes one or more panels 300 secured to and between the front and rear frame portions 110, 120. In example embodiments, the panels 300 are configured to cover the gaps or openings between front and rear frame portions 110, 120 under the hinge components to prevent child users from passing any part of their body through the openings, which can lead to serious injury or conditions. For example, the openings defined by the front frame portion 110, the rear frame portion 120, and the child support platform 140 pose a potential risk of head and neck entrapment. According to example embodiments, the side edges or bindings 310 of the panels 300 are preferably permanently affixed to the first legs 112, 114 and second legs 122, 124 of front and rear frame portions 110, 120, as shown in FIGS. 3-6.

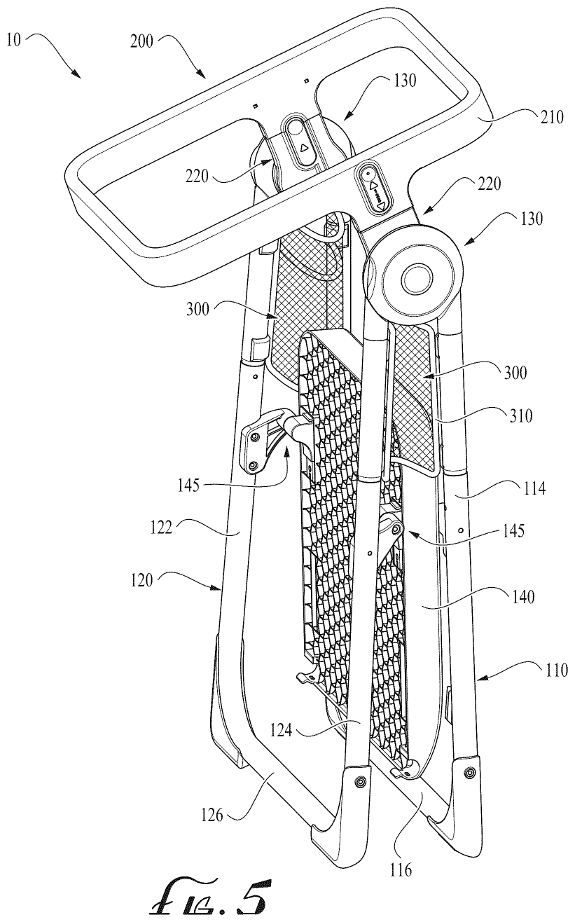

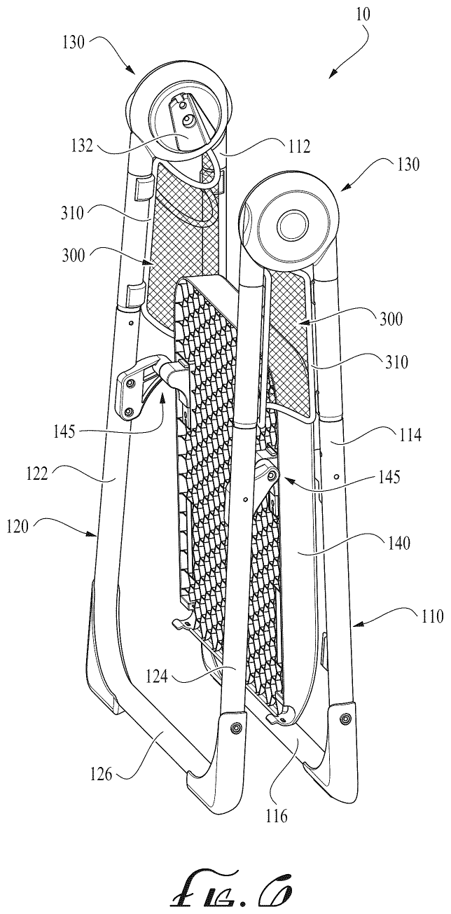

In example embodiments, the top and bottom edges or bindings 320 of the panels 300 are not permanently affixed to the base 100, allowing the panels 300 to freely deform so as not to impede or prevent the user from closing or folding the base for storage or when not in use (see, e.g., FIGS. 5 and 6). In example embodiments, the top edges of the panels are configured to match or conform to the exterior shape of the hinge component 130 to minimize or eliminate the gap or opening between the panels 300 and the hinge components 130, as best shown in FIG. 3. The bottom edges of the panels may extend as far from the top edges as required or desired. For example, the bottom edges of the panels may extend to the support surface (i.e., the ground or floor). Preferably, the bottom edges of the panels extend below the child support platform 140 to minimize or eliminate any gap or opening between the safety panels 300 and child support platform 140. In some example embodiments, one or both of the panels 300 may comprise one or more integrated pockets 340 for storing and holding other items, as best shown in FIG. 4. In some embodiments, the bottom bindings 320 could be semi-permanently affixed (e.g. using hook and loop or other removable fastener) to the edge or underside of the child support platform 140 for aesthetic purposes.

In example embodiments, the panels 300 are preferably children-friendly soft-goods material, such as for example mesh or fabric liners. However, other suitable materials may also be used, such as for example, other textiles, synthetic fabrics such as polyester, nylon, polypropylene, spandex, polyethylene, polyvinyl chloride, and/or polyurethane, or leather and faux leather, or any combinations thereof.

In some example embodiments, the base 100 further includes an intermediate platform or step 150 connected to and extending between the first and second legs 122, 124 of the rear frame portion 120. The step 150 is generally positioned at some elevation or height along the second pair of legs of rear frame portion 120 between the child support platform 140 and support surface so as to provide an intermediate step between the support surface and the child support platform for the child user to step up to and down from the child support platform more conveniently and safely.

FIGS. 5 and 6 show two configurations for folding the toddler tower 10, such as for storage. As can be appreciated from the figures, the child support platform 140 is hingeably connected to the frame by platform hinges 145 so that the child support platform can be raised at one edge to allow for folding. Advantageously, frame 110 includes pegs on which the free end of child support platform 140 can sit for support without the need for support crossbars between the legs to support the child support platform 140. Platform hinges 145 are depicted as coupling the rear edge of the child support platform 140 to the rear frame 120, but could be alternatively connected at the front frame instead, as can be envisioned by a person having ordinary skill in the art. While the toddler tower 10 is in the folded position, guardrail 200 can remain attached as shown in FIG. 5. Alternatively, guardrail 200 can be removed from the toddler tower 10 to allow for more compact storage when in the folded position. As can be seen, panels 300 deform so as not to interfere with the folding of the tower.

The embodiment depicted in FIGS. 5 and 6 does not include step 150. The toddler tower 10 can include the step 150 or can be provided in a version without a step 150.

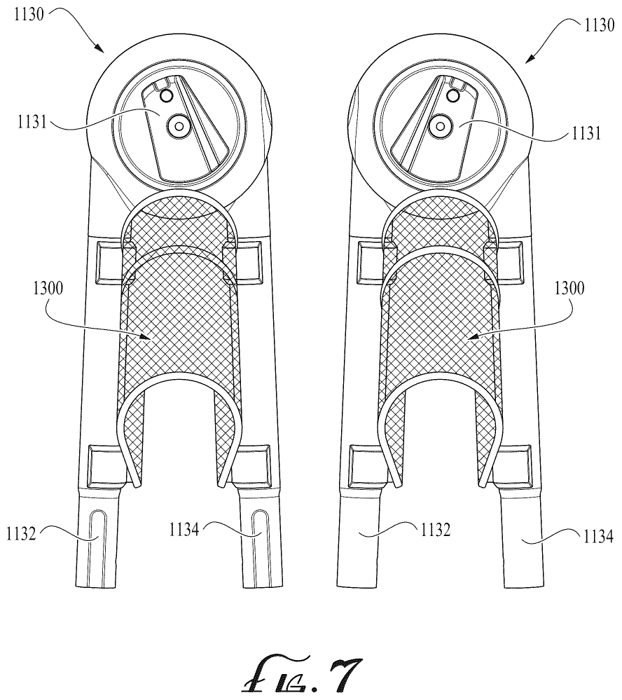

FIG. 7 shows hinge assemblies 1130 according to another example embodiment of the present invention. Each of the hinge assemblies 1000 comprises a hinge component 1131 as described above, a first extension 1132 extending from a first portion of the hinge component 1131, and a second extension 1134 extending from a second portion of the hinge component 1131. In example embodiments, the first and second extensions 1132, 1134 are configured to pivot or hinge relative to one another about the hinge component 1130. The free ends of each of the first and second extensions 1132, 1134 are configured for connecting to the free ends of the first and second legs 112, 114, 122, 124 of the front and rear frame portions 110, 120. The hinge assembly 1130 further includes a panel 1300, similar to the panels described above. In this depicted embodiment, the side edges 1310 or bindings of the panel 1300 are secured to the first and second extensions 1132, 1134 (rather than the first and second legs of the front and rear frame portions as described above). The first and second extensions 1132, 1134 can be removably attached to legs and to the hinge component 1131 by such as push buttons for easy assembly by a user.

According to example embodiments of the present invention, the toddler tower is reconfigurable between an open configuration and a folded or closed configuration. The hinge components 130 allow the front and rear frame portions to hinge relative to one another. Preferably, the toddler tower 10 comprises a base locking mechanism, for example in the hinge components 130, to lock the toddler tower in the open configuration during use and prevent the toddler tower from folding unintentionally. The base locking mechanism may also be configured to lock the toddler tower in the closed configuration to prevent the base from opening unexpectedly during transport or set up. The base locking mechanism can include mechanisms such as push release buttons.

Advantageously, the toddler tower 10 can be part of a modular system including compatible components. For example, the child support platform 140 can receive a highchair seat, infant seat, booster seat, bassinet or other compatible component. In some embodiments, the guardrail 200 can be removed and the compatible component coupled with the sliding blocks 132 extending from the hinge components 130 to secure the compatible component to the toddler tower 10.

While the invention has been described with reference to example embodiments, it will be understood by those skilled in the art that a variety of modifications, additions and deletions are within the scope of the invention, as defined by the following claims.

What is claimed is:

1. A toddler tower, comprising
a base having a first pair of legs hingeably connected to a second pair of legs,
a child support platform extending between the first and second pairs of legs, and
at least one panel extending between the first and second pairs of legs.

2. The toddler tower of claim 1, wherein the at least one panel comprises an integrated pocket.

3. The toddler tower of claim 1, wherein the panel is defined by a first binding, a second binding, and a third binding.

4. The toddler tower of claim 3, wherein the first binding of the panel is secured to a first leg of the first pair of legs and the second binding of the panel is secured to a first leg of the second pair of legs.

5. The toddler tower of claim 4, wherein the third binding is aligned with the child support platform.

6. The toddler tower of claim 3, further comprising a second panel, wherein the first binding of the panel is secured to a second leg of the first pair of legs and the second binding of the panel is secured to a second leg of the second pair of legs.

7. The toddler tower of claim 1, wherein the panel is a mesh liner.

8. The toddler tower of claim 1, wherein the panel comprises a non-perforated fabric liner.

9. A toddler learning tower for supporting a toddler above a support surface, comprising
a base portion having a first pair of legs connected to a second pair of legs by hinge components, wherein a first leg of the first pair of legs is connected to a first leg of the second pair of legs by a first hinge component and a second leg of the second pair of legs is connected to a second leg of the second pair of legs by a second hinge component;
a child support platform extending between the first and second legs of the first and second pairs of legs at a first elevation above the support surface;
a step platform extending between the first and second legs of at least one of the first or second pairs of legs at a second elevation above the support surface, wherein the second elevation is lower than the first elevation; and
a first soft-goods panel extending between the first legs of the first and second pairs of legs.
a second soft-goods panel extending between the second legs of the first and second pairs of legs.

10. The toddler learning tower of claim 9, wherein the first and second soft-goods panel are mesh panels.

11. The toddler learning tower of claim 9, wherein the first and second soft-goods panel are fabric panels.

12. The toddler learning tower of claim 9, wherein at least one of the first or second soft-goods panels comprises an integrated pocket.

13. The toddler learning tower of claim 9, further comprising a guardrail.

14. The toddler learning tower of claim 13, wherein the guardrail comprises a slider rail configured to slidably engage the first and second hinge components.

15. The toddler learning tower of claim 14, wherein each of the first and second hinge components comprise a guide block or a protrusion configured to engage the slider rail.

16. The toddler learning tower of claim 15, wherein the guardrail further comprises a locking mechanism for releasably locking the guardrail to the first and second hinge components.

17. The toddler learning tower of claim 9, wherein the first and second pairs of legs are removably attached to the first and second hinge components so that the first and second pairs of legs are selectively removable from the first and second hinge components.
